(19) United States
(12) Patent Application Publication
(10) Pub. No.: US 2009/0320126 A1
(43) Pub. Date: Dec. 24, 2009

(54) INFORMATION PROCESSING APPARATUS AND METHOD

(75) Inventor: Koji Harada, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/487,288

(22) Filed: Jun. 18, 2009

(30) Foreign Application Priority Data
Jun. 23, 2008 (JP) 2008-163704

(51) Int. Cl. H04L 9/32; G10L 11/00; G06F 21/00

(52) U.S. Cl. 726/18; 704/273; 704/E11.001; 726/19

(57) ABSTRACT

An information processing apparatus sets positional relationship information indicating positional relationship between a designated position, which is to be designated on a screen by a user in a case where a plurality of images inclusive of the pass image are displayed on the screen at the time of authentication, and a display position of the pass image (S208). The apparatus then creates authentication information, which includes the image information of the pass image and the set positional relationship information, and registers the authentication information in a memory (S211).

### BACKGROUND OF THE INVENTION

1. Field of the Invention

The present invention relates to a technique relating to authentication.

2. Description of the Related Art

Various personal authentication methods have been proposed heretofore, and image-based authentication methods, which are personal authentication methods that employ an image, have become the focus of attention. The reason is to eliminate a particular problem that arises with an authentication method that uses an account and password, the problem being that a character string (which is meaningless) must be memorized and the character string must be remembered perfectly, without any mistakes, at the time of authentication. More specifically, with an image-based authentication method, long-term visual memory, which is the forte of a human being, is utilized and an image (a pass image) is memorized instead of a password and the pass image is designated from among displayed images at the time of authentication.

Although an image-based authentication method is highly convenient in the manner set forth above, a problem arises in terms of security, namely in that a pass image can readily be guessed as by Brute force attack.

Non-Patent Document 1 proposes making it difficult to guess a pass image in a system in which an image group is displayed a plurality of times at the time of authentication, this being achieved by mixing in times when the pass image is not included in the image group.

Further, Patent Document 1 proposes a technique the object of which is to make it difficult to guess a password even in a case where the password input operation happens to be seen by another person, although this technique does not relate to an image authentication method. Specifically, although numerals 1 to 9 are displayed on a display unit, the technique displays a random graphic pattern (in which numerals are displayed inversely in black or white) that is different every time. For example, assume that a password registered by a user is 2 black, 4 black, 5 black and 9 black (i.e., the numerals 2, 4, 5, 9 are displayed as black and numerals other than these are displayed inversely as white numerals). If the display at the time of authentication is 1 black, 2 white, 3 black, 4 black, 5 black, 6 white, 7 white, 8 black and 9 white, then all of the numbers for which the display differs from the numbers of the user's own password are numbers that should be input; authentication will succeed if 1, 2, 3, 8, 9 can be input. As a result, a black-and-white display factor is used in addition to the conventional password that relies solely upon numerals. That is, by allowing input of numerals other than a password, it is difficult for another person to guess the password.

[Non-Patent Document 1]

Transactions of Information Society of Japan, Vol. 44, No. 8 “Awase-E: Method of Reinforcing Image-Based Authentication by Positive Candidate Selection Using Image Registration and User Notification”

[Patent Document 1]

Japanese Patent Laid-Open No. 6-214954

With the technique described in Non-Patent Document 1, convenience is enhanced since use is made of an easy-to-remember pass image at the time of authentication. However, a disadvantage is that if the operation for designating the pass image happens to be seen by another person, the pass image will be readily revealed. Hence, a problem still remains in terms of security.

With the technique described in Patent Document 1, consideration is given to security in that it is difficult for another person to guess a password even if the password input operation happens to be seen by the other person. However, it is necessary to memorize a password that is a meaningless character string and consideration must be given to input every time. This is inconvenient.

### SUMMARY OF THE INVENTION

The present invention has been devised in view of the foregoing problems and seeks to provide a technique for realizing authentication in which not only does a user employ comparatively easy-to-memorize information as a password but which also makes it difficult for a password to be guessed even if seen by another person.

According to the first aspect of the present invention, an information processing apparatus comprising: an acquisition unit for acquiring image information of a pass image used at the time of authentication; a setting unit for setting positional relationship information indicating positional relationship between a designated position, which is to be designated on a screen by a user in a case where a plurality of images inclusive of the pass image are displayed on the screen at the time of authentication, and a display position of the pass image; and a registration unit for generating authentication information, which includes the image information acquired by the acquisition unit and the positional relationship information set by the setting unit, and registering the generated authentication information in a memory.

Further features of the present invention will become apparent from the following description of exemplary embodiments with reference to the attached drawings.

### BRIEF DESCRIPTION OF THE DRAWINGS

FIG. 1 is a block diagram illustrating an example of the functional configuration of an information processing apparatus according to a first embodiment of the present invention;

FIG. 2 is a flowchart of processing for registering user authentication data;

FIG. 3 is a diagram illustrating an example of a screen displayed at a step S207 in the flowchart of FIG. 2;

FIG. 4 is a flowchart of processing executed at the time of authentication;

FIG. 5 is a diagram illustrating an example of the configuration of a system according to a second embodiment of the present invention; and

FIG. 6 is a block diagram illustrating an example of the hardware configuration of a computer applicable to an information processing apparatus.

### DESCRIPTION OF THE EMBODIMENTS

Preferred embodiments of the present invention will be described in detail below with reference to the accompanying drawings. The embodiments will be described as an example of a preferred arrangement of the present invention described in the scope of the claims. The invention is not limited to the embodiments described below.

### First Embodiment

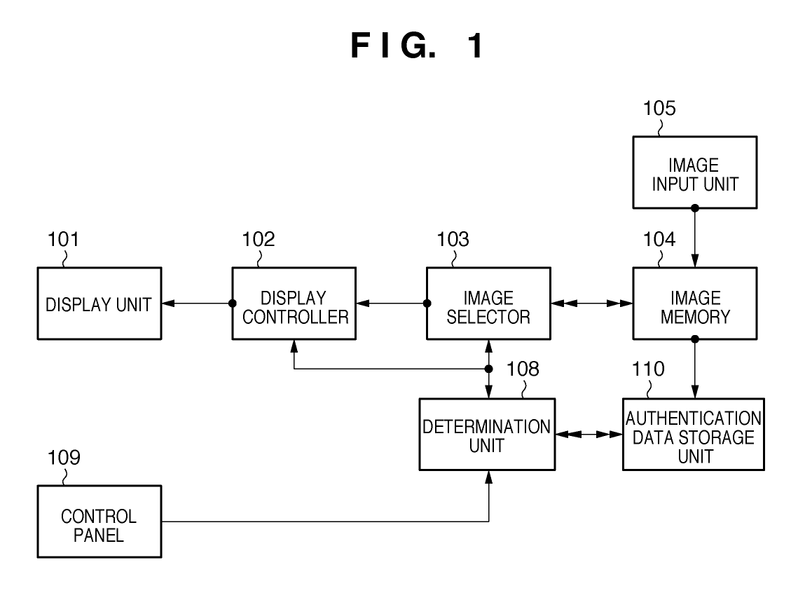

FIG. 1 is a block diagram illustrating an example of the functional configuration of an information processing apparatus according to this embodiment. As illustrated in FIG. 1, the information processing apparatus according to this embodiment includes an image input unit 105, an image memory 104, an authentication data storage unit 110, a determination unit 108, an image selector 103, a display controller 102, a display unit 101 and a control panel 109.

The display unit 101 is constituted by a CRT and liquid crystal screen and displays images and text in accordance with control performed by the display controller 102.

The display controller 102 exercises overall control relating to the display presented on the display unit 101. For example, the display controller 102 executes control processing for generating a screen and displaying the screen on the display unit 101. The screen is for displaying, in the form of an array, the images in an image group received as display images from the image selector 103.

The image selector 103 reads the image group, which is for display on the display unit 101, out of the image memory 104 and sends the read image group to the display controller 102.

A plurality of images have been registered in the image memory 104. The registered images may be any images as long as they are images that are easy for the user to remember visually over a comparatively long period of time. Examples of these images are photographic images, illustration images, solid-color images and characters such as numerals.

The image input unit 105 is for inputting an image to be registered in the image memory 104. For example, the image input unit 105 is constituted by a digital camera or by an interface for connecting a digital camera. That is, there is no particular limitation with regard to the form of image acquisition. As long as the image can be input to the apparatus, any form of input may be adopted.

The determination unit 108 executes various authentication-related processes using the authentication data that has been stored in the authentication data storage unit 110.

Authentication data (authentication information) on a per-user basis has been registered in the authentication data storage unit 110.

The control panel 109 is operated by the user in order to input various commands to the apparatus and is constituted by a group of hard keys. It should be noted that the display unit 101 and control panel 109 may be integrated into a single unit in the form of a touch-sensitive panel.

Next, processing executed by the information processing apparatus according to this embodiment will be described in detail. Processing executed by the information processing apparatus according to this embodiment is divided broadly into two portions, namely processing for registering user authentication data and authentication processing.

Processing for registering user authentication data will be described first.

<Processing for Registering User Authentication Data>

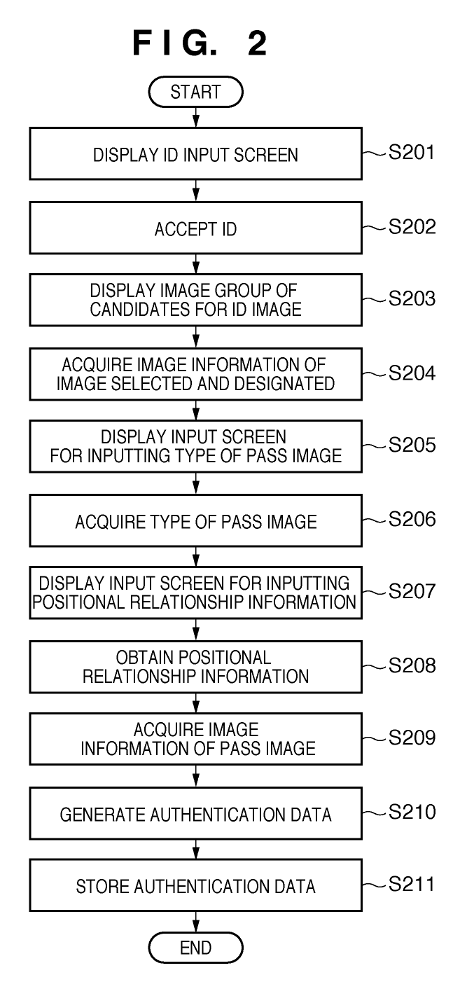

FIG. 2 is a flowchart of processing for registering user authentication data.

First, at step S201, the display controller 102 displays a screen on the display unit 101 in order to allow input of a user ID. Using the control panel 109, the user inputs his own unique ID on the displayed screen. For example, the user is capable of inputting his own surname “Tanaka” as the ID using the control panel 109.

At step S202, the determination unit 108 acquires and stores temporarily the ID that the user entered using the control panel 109.

Next, at step S203, in order to perform registration of an ID image, which is an image used initially at the time of registration, the image selector 103 reads out a group of images from the image memory 104 in a number that can be displayed on the display unit 101 at one time and sends the read image group to the display controller 102. The display controller 102 displays the image group in the form of an array on the screen of the display unit 101. The images in the image group displayed in array form are ID image candidates. The user selects one image from the image group as an ID image using the control panel 109. If the image group displayed in array form does not contain an image that the user wishes to use as an ID image, then the user employs the control panel 109 and inputs an indication calling for the next image group to be displayed. In response, the image selector 103 reads a new image group out of the image memory 104 and sends the read image group to the display controller 102. The display controller 102 displays this image group on the screen of the display unit 101 in the form of an array.

At step S204, the determination unit 108 acquires and stores temporarily the image information (e.g., a file name) of the ID image selected and designated by the user.

It should be noted that the method of registering an ID image in this apparatus is not limited to that described above and other methods are conceivable. For example, using the image input unit 105, the user may send the determination unit 108 an image that the user has prepared as an ID image in advance. As one example, if the image input unit 105 is an image sensing device, the user can image his own face using the image sensing device. The image sensing operation is performed using the control panel 109. The image input unit 105 then transmits the captured image obtained by such imaging to the determination unit 108 as the ID image. The determination unit 108 acquires the image information (e.g., the file name) of this ID image and stores it temporarily.

Next, at step S205, the display controller 102 causes the display unit 101 to display a screen for inputting the type of pass image in order to register the type of pass image, which will function as a password. Examples of types of pass images that can be mentioned are photographs, illustrations, solid color fills or characters such as numerals. In this case, therefore, check boxes are displayed together with respective ones of “photo”, “illustration”, “solid color fill” and “character such as numeral” and the user checks any one of these check boxes using the control panel 109. This makes it possible to select the type that corresponds to the checked box.

Next, at step S206, the determination unit 108 acquires the type of pass image selected by the user using the control panel 109 and stores the type temporarily.

At the time of authentication, the image group inclusive of the pass image (images other than the pass image may be changed if desired whenever the display is presented) is displayed. At this time, however, the user does not designate the pass image but instead designates an image spaced away from the pass image by an offset amount set by subsequent processing. As a result, even if the operation performed at the time of authentication happens to be seen by another person, it is difficult for the other person to guess the pass image from the operation because the user designates an image (other than the pass image) that changes with every display (the designated image is in a prescribed positional relationship with respect to the pass image).

At step S207, therefore, the display controller 102 causes the display unit to display a screen for setting the offset.

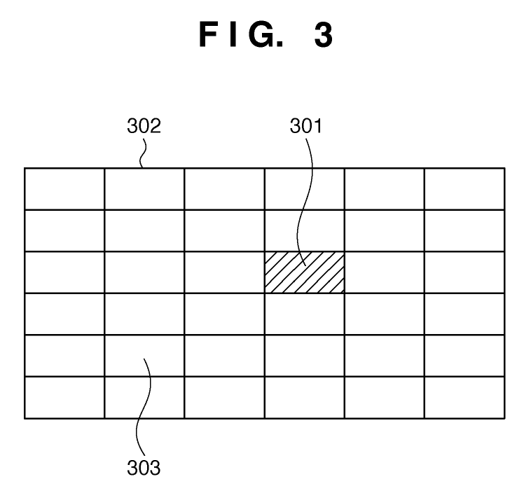

FIG. 3 is a diagram illustrating an example of the screen displayed at step S207. At the time of authentication, a screen on which the group of images inclusive of the pass image have been arrayed is displayed. On the screen shown in FIG. 3, the images on the screen are illustrated as rectangular regions. In FIG. 3, reference numeral 302 denotes a set of rectangular regions indicating the display positions of the respective images in the image group inclusive of the pass image displayed at the time of registration. When images are displayed within the rectangular-region group 302 on this screen and the pass image is displayed in a rectangular region 301 at the time of authentication, the user sets which image at a position spaced a certain desired distance away from the rectangular region 301 should be pointed at.

For example, if the user has designated a rectangular region 303 using the control panel 109, the determination unit 108 finds the positional relationship between the rectangular region 301 and the rectangular region 303. In this case, “two to the left and two down” is the positional relationship. In this case, therefore, the determination unit 108 creates positional relationship information indicating “two to the left and two down” and stores this information temporarily. The method of using the positional relationship information will be touched upon when processing executed at the time of authentication is described.

Accordingly, when the user designates one rectangular region by the control panel 109 on the screen displayed at step S207 in the manner set forth above, the determination unit 108 accepts the designation at step S208. The determination unit 108 obtains the positional relationship information indicating the positional relationship between the designated rectangular region and the rectangular region 301. The determination unit 108 stores the obtained positional relationship information temporarily. On the screen shown in FIG. 3, the display position of the pass image is adopted as the position of the rectangular region 301. However, since the purpose of this screen in the first place is to register the positional relationship between the position of the image to be pointed at by the user and the position of the pass image in a case where an image group inclusive of the pass image is displayed at the time of authentication, the position of the rectangular region 301 is nothing more than a reference for obtaining the positional relationship. Accordingly, the position of the rectangular region 301 may just as well be the position of any rectangular region in the rectangular-region group 302. Further, the method of registering the positional relationship is not limited to this method for this reason; any method may be adopted so long as a similar purpose can be achieved. This point will be described later in another embodiment.

Next, at step S209, in order to register the pass image, the image selector 103 reads out a group of images from the image memory 104 in a number that can be displayed on the display unit 101 at one time and sends the read image group to the display controller 102. The image group corresponds to the type of pass image selected by the user at step S205. The display controller 102 displays the image group in the form of an array on the screen of the display unit 101. The images in the image group displayed in array form are pass image candidates. The user selects one image from the image group as a pass image using the control panel 109. If the image group displayed in array form does not contain an image that the user wishes to use as a pass image, then the user employs the control panel 109 and inputs an indication calling for the next image group to be displayed. In response, the image selector 103 reads a new image group out of the image memory 104 and sends the read image group to the display controller 102. The display controller 102 displays this image group on the screen of the display unit 101 in the form of an array.

The determination unit 108 acquires and stores temporarily the image information (e.g., the file name) of the pass image selected and designated by the user.

It should be noted that the method of registering a pass image in this apparatus is not limited to that described above and other methods are conceivable. For example, using the image input unit 105, the user may send the determination unit 108 an image that the user has prepared as a pass image in advance. As one example, if the image input unit 105 is a connector for connecting a storage medium, the user connects a storage medium, on which an image for use as a pass image has been recorded, to the image input unit 105 and uses the control panel 109 to designate that this pass image is to be transferred to the apparatus. When this designation is input to the image input unit 105, the latter reads the pass image out of the storage medium and sends it to the determination unit 108.

At step S210, the determination unit 108 creates data for authentication that includes each of the items of information acquired and stored temporarily by the above-described processing. The data for authentication includes the ID, the image information of the ID image, the type of pass image, the positional relationship information and the image information of the pass image.

At step S211, the determination unit 108 stores this authentication data created at step S210 in the authentication data storage unit 110, which serves as a memory.

As a result of the processing described above, authentication data for a single user can be created and registered in the authentication data storage unit 110.

Processing at the time of authentication will be described next.

<Processing at Time of Authentication>

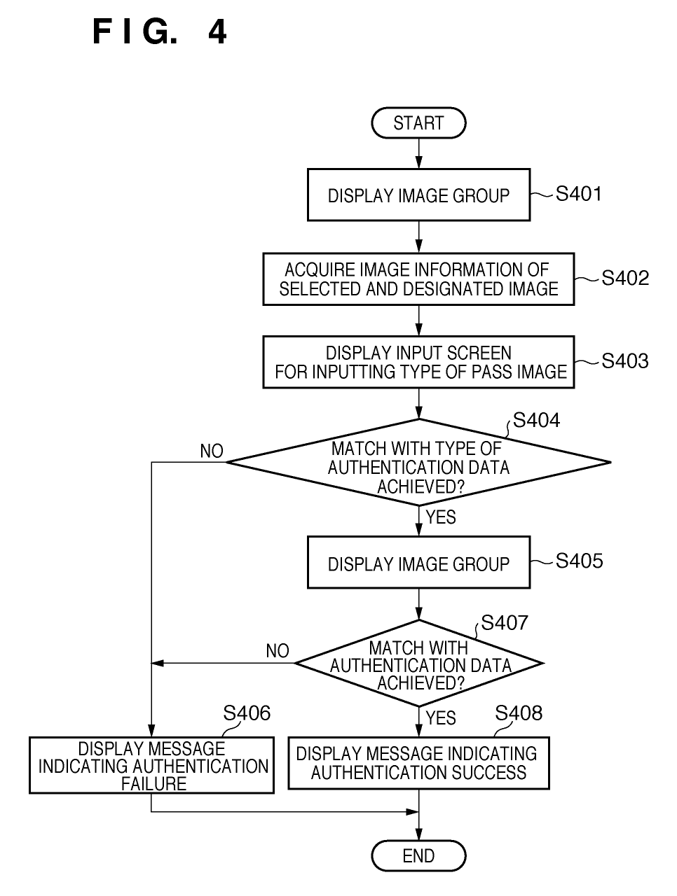

FIG. 4 is a flowchart of processing executed at the time of authentication. The user inputs his own ID before processing in accordance with the flowchart of FIG. 4 is started. The determination unit 108 searches the authentication data storage unit 110 for the data for authentication that includes the entered ID. If the result of the search is that the authentication data that includes the entered ID is found in the authentication data storage unit 110, then the found authentication data is retrieved as authentication data of interest (authentication information of interest). If the authentication data is not found, on the other hand, then the display controller 102 causes the display unit 101 to display a message indicating that authentication has failed and also inhibits execution of processing that has been set for execution after authentication processing.

At step S401, the image selector 103 reads out a group of images from the image memory 104 in a number that can be displayed on the display unit 101 at one time and sends the read image group to the display controller 102. The display controller 102 displays the image group in the form of an array on the screen of the display unit 101. If the image group contains an image that the user has set as his ID image, then the user selects this image using the control panel 109. If the image group does not contain an ID image registered by the user, then the user uses the control panel 109 to enter a command to display the next group. In response, the image selector 103 reads a new image group (an image group different from the previous image group) out of the image memory 104 and sends this read image group to the display controller 102. The display controller 102 displays this image group on the screen of the display unit 101 in the form of an array. An ID image that has been registered by the user should always be displayed in some one of the array displays.

At step S402, the determination unit 108 acquires the image information (e.g., the file name) of the image selected and designated by the user and stores this information temporarily.

Next, at step S403, the display controller 102 causes the display unit 101 to display a screen for inputting the type of pass image. For example, check boxes are displayed together with respective ones of “photo”, “illustration”, “solid color fill” and “character such as numeral”. Using the control panel 109, the user places a check in the check box corresponding to the type of pass image that the user himself has registered, thus enabling the type corresponding to the checked box to be selected and designated. At step S403, therefore, the type selected and designated by the user using the control panel 109 is accepted after this screen is displayed.

Next, at step S404, the determination unit 108 determines whether there is a match between the type of pass image contained in the authentication data of interest and the type accepted from the user at step S403. If the result of the determination is that there is no match, then control proceeds to step S406.

At step S406, the display controller 102 causes the display unit 101 to display a message indicating that authentication has failed and also inhibits execution of processing that has been set for execution after authentication processing. It should be noted that in addition to displaying an authentication failure message at step S406, processing for notifying an administrator or processing for issuing an alert tone may be executed.

On the other hand, if the result of the determination made at step S404 is a match, then control proceeds to step S405.

At step S405, the image selector 103 reads out a group of images from the image memory 104 in a number that can be displayed on the display unit 101 at one time and sends the read image group to the display controller 102. The display controller 102 displays this image group on the screen of the display unit 101 in the form of an array. If the image group does not contain a pass image registered by the user himself, the user employs the control panel 109 and inputs an indication calling for the next image group to be displayed. In response, the image selector 103 reads a new image group out of the image memory 104 and sends the read image group to the display controller 102. The display controller 102 displays this image group on the screen of the display unit 101 in the form of an array.

If the user finds a pass image registered by the user himself, the user does not select and designate this pass image but instead selects and designates the image having the positional relationship indicated by the positional relationship information that the user registered.

Next, at step S407, the determination unit 108 specifies the image having the positional relationship indicated by the position (designated position) of the image selected and designated by the user and the positional relationship information contained in the authentication data of interest, and then acquires the image information of the specified image. For example, if the positional relationship indicated by the positional relationship information is “two to the left and two up”, then the determination unit 108 specifies the image at a position offset by “two to the right and two down” from the position of the image selected and designated by the user and acquires the image information of the specified image.

It should be noted that if the selected and designated image is at a position that is second from the left and the positional relationship information indicates “five to the left”, the position third from the right would correspond to “five to the left”. Similarly, with regard also to the vertical direction, the position is found by moving the image in from one side by the amount of overflow from the opposite side. It is then determined whether the acquired image information matches the image information of the pass image contained in the authentication data of interest.

If the result of this determination is a non-match, control proceeds to step S406. If a match is achieved, on the other hand, then control proceeds to step S408.

At step S408, the display controller 102 causes the display unit 101 to display a message indicating that authentication has succeeded (authentication successful) and permits execution of processing (subsequent processing) that has been set for execution after authentication processing.

Thus, even if the authentication operation happens to be seen by another person, the fact that the pass image is not actually designated means that the security level of such authentication is very high. In order to raise the security level even further, a method of registering a plurality of pass images and performing authentication and a method of registering positional relationship information and performing authentication per pass image of a plurality of pass images are conceivable.

Further, in a system such as a small-scale system in which the number of users is limited, it may be so arranged that if there is no duplication of pass images, ID registration, etc., can be omitted and only registration of a pass image and registration of position relationship information is carried out. Naturally, this would be supported on the authentication side as well.

In the foregoing embodiment, various designations and inputs are performed using the control panel 109. However, it may be so arranged that designations and inputs are made by speech. In this case, it is required that the apparatus be additionally provided with a speech input unit such as a microphone for inputting speech, and a speech recognition unit for executing speech recognition processing based upon a speech signal that has been input via the speech input unit. Various designations are input based upon results of such speech recognition.

Further, a plurality of images are displayed on the screen in the foregoing embodiment. However, it may be so arranged that images are displayed one at a time in a case where the screen size of the display unit 101 is small or the information processing capability of the information processing apparatus is low.

### Second Embodiment

The first embodiment illustrates an example in which the same apparatus executes both processing for registering authentication data and authentication processing. However, it may be so arranged that these processing operations are implemented by respective ones of separate devices. In this embodiment, the processing for registering authentication data is executed by a personal computer, etc., at home. The authentication processing is executed at a terminal that has been installed at a public place.

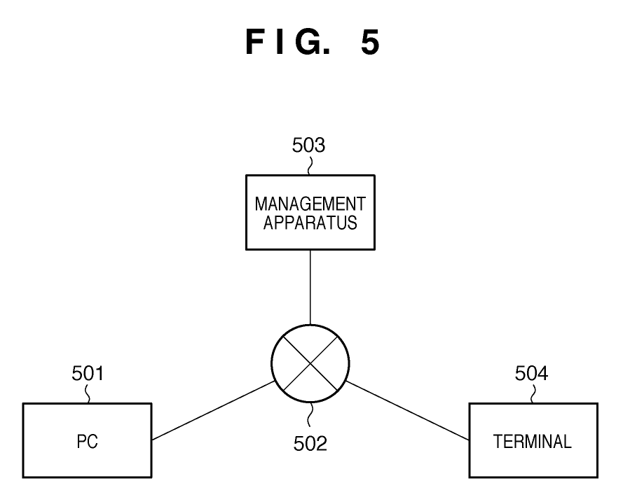

FIG. 5 is a diagram illustrating an example of the configuration of a system according to this embodiment.

A personal computer 501 in FIG. 5 is located at a user's home, etc., and the functional configuration thereof is obtained by omitting the authentication data storage unit 110 from the arrangement shown in FIG. 1. The user performs the authentication data registration operation at home and therefore the personal computer 501 executes processing conforming to the flowchart of FIG. 2. The authentication data generated by this processing is transmitted to a management apparatus 503 via a network 502. The management apparatus 503 functions as the authentication data storage unit 110 and stores the authentication data transmitted from the personal computer 501 via the network 502. Authentication data of each user managed by the management apparatus 503 is transmitted to a terminal 504 via the network 502 as necessary in accordance with a request from the terminal 504.

The terminal 504 has a configuration obtained by eliminating the authentication data storage unit 110 from the functional configuration shown in FIG. 1 and executes processing that requires authentication, e.g., processing similar to that performed by an ATM at a bank.

In a case where a user employs the terminal 504 to perform an operation that requires authentication, the terminal 504 executes processing conforming to the flowchart of FIG. 4. At such time the terminal 504 acquires the data for user authentication from the management apparatus 503 via the network 502.

Although various applications are conceivable for a system that requires authentication processing, the system according to this embodiment can find use in such diverse applications.

### Third Embodiment

In the first embodiment, the display position of a pass image is provided at a prescribed position on a screen in order to set what position spaced away from the pass image is to be designated (i.e., in order to set the positional relationship information) at the time of registration, and a screen for allowing a user to select any one rectangular region is displayed. However, the method of setting the positional relationship information is not limited to specific method. For example, it may be so arranged that in a case where the setting is made by speech input, as mentioned above, the positional relationship information indicating “two to the left and two up” may be input directly by uttering “two to the left and two up”. In this case, the determination unit 108 stores the positional relationship information, which has been entered by speech, as is temporarily without performing computation for finding the positional relationship information.

### Fourth Embodiment

In the foregoing embodiments with the exception of the second embodiment, it is described that the units shown in FIG. 1 are all implemented by hardware. However, the image selector 103 and determination unit 108 may be implemented by software and the other units by hardware. In this case, a computer which has the units other than the image selector 103 and determination unit 108 as hardware and which executes software corresponding to the image selector 103 and determination unit 108 can be applied to the above-described information processing apparatus.

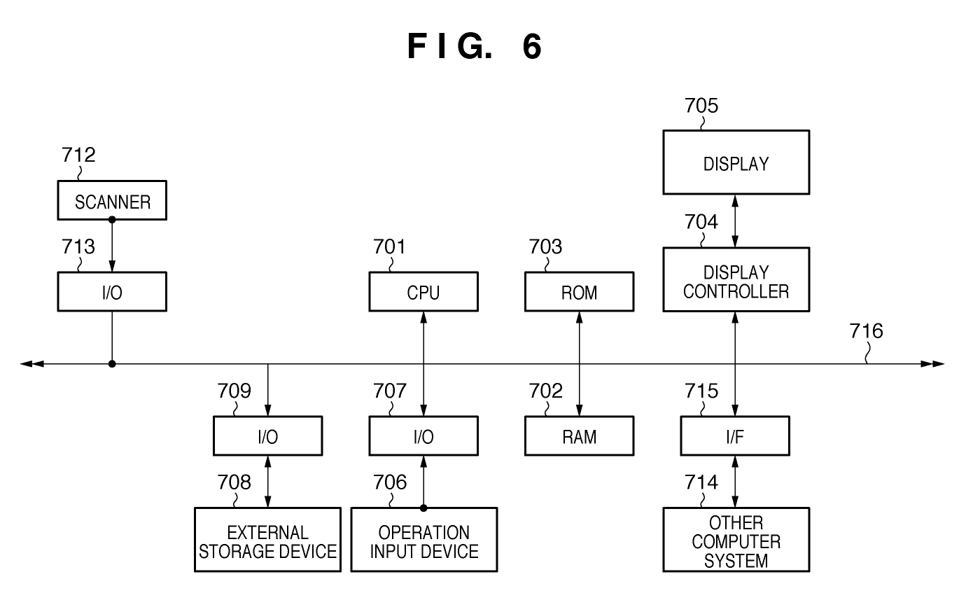

FIG. 6 is a block diagram illustrating an example of the hardware configuration of a computer applicable to an information processing apparatus.

A CPU 701 controls the overall computer using a computer program and data that have been stored in a RAM 702 and ROM 703 and executes the above-described processing operations performed by the information processing apparatus.

The RAM 702 has areas for temporarily storing a computer program and data loaded from an external storage device 708, image data read by a scanner 712 and data, etc., transmitted from another computer system 714. The RAM 702 further has a work area used when the CPU 701 executes various processing. That is, the RAM 702 is capable of providing various areas as necessary.

The settings data and booting program, etc., of the computer have been stored in the ROM 703.

A scanner 712 is connected to an I/O interface 713, and the result of reading by the scanner 712 is sent to the RAM 702 and external storage device 708 via the I/O interface 713 as image data. The image data can be used as an ID image or pass image.

A display 705 is constituted by a CRT and liquid crystal screen, etc., and can display the result of processing by the CPU 701 as images and text, etc. For example, the various screen mentioned in the first embodiment are displayed on the display 705. That is, the display 705 functions as the display unit 101 shown in FIG. 1. The operation of the display 705 is controlled by a display controller 704. That is, the display controller 704 functions as the display controller 102 shown in FIG. 1.

The external storage device 708 is a large-capacity information storage unit typified by a hard-disk drive. Stored on the external storage device 708 are an operating system as well as computer programs and data that cause the CPU 701 to execute the above-described processing operations performed by the information processing apparatus. The computer programs include computer programs that cause the CPU 701 to execute the above-described processing operations performed by the image selector 103 and determination unit 108. The data includes the data of the ID image and the data of the image group in which the images are candidates for a pass image.

The computer programs and data that have been stored in the external storage device 708 are loaded appropriately in the RAM 702 via an I/O interface 709 in accordance with control by the CPU 701 and become the target of processing by the CPU 701.

An operation input device 706 is constituted by a keyboard and mouse, etc., and is operated by the user of the computer to input various commands to the CPU 701 via an I/O interface 707. That is, the operation input device 706 functions as the control panel 109 shown in FIG. 1.

The other computer system 714 is connected to this computer via an interface 715.

The I/O interfaces 707, 709 and 713, CPU 701, ROM 703, RAM 702, display controller 704 and interface 715 are connected by a bus 716 and are capable communicating with one another via the bus 716.

It should be noted that the embodiments described above may be used upon being combined appropriately.

### Other Embodiments

It goes without saying that the object of the invention is attained also by supplying a recording medium (or storage medium) on which the program code (computer program) of the software for performing the functions of the foregoing embodiments to a system or an apparatus has been recorded. It goes without saying that the storage medium is a computer-readable storage medium. A computer (e.g., a CPU or MPU) of the system or apparatus then reads the program code from the recording medium on which the code has been stored. In this case, the program code read from the recording medium itself implements the functions of the embodiments, and the recording medium storing the program code constitutes the invention.

Further, by executing the program code read out by the computer, an operating system or the like running on the computer executes some or all of the actual processing based upon the indications in the program code. A case where the functions of the above-described embodiments are implemented by this processing also is covered by the present invention.

Furthermore, program code read from a recording medium is written to a memory provided on a function expansion card inserted into the computer or provided in a function expansion unit connected to the computer. Thereafter, a CPU or the like provided on the function expansion card or function expansion unit performs some or all of actual processing based upon the indication in the program code, and the functions of the above embodiments are implemented by this processing. Such a case also is covered by the present invention.

In a case where the present invention is applied to the above-mentioned recording medium, programs corresponding to the flowcharts described above are stored on the recording medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-163704, filed Jun. 23, 2008, which is hereby incorporated by reference herein in its entirety.

What is claimed is:

1. An information processing apparatus comprising:
an acquisition unit for acquiring image information of a pass image used at the time of authentication;
a setting unit for setting positional relationship information indicating positional relationship between a designated position, which is to be designated on a screen by a user in a case where a plurality of images inclusive of the pass image are displayed on the screen at the time of authentication, and a display position of the pass image; and
a registration unit for generating authentication information, which includes the image information acquired by said acquisition unit and the positional relationship information set by said setting unit, and registering the generated authentication information in a memory.

2. The apparatus according to claim 1, wherein said setting unit includes:
a display unit for displaying a rectangular-region group that includes a rectangular region indicating the display position of the pass image; and
a unit for obtaining a positional relationship between a rectangular region that is designated by the user in the rectangular-region group and a rectangular region indicating the display position of the pass image, and setting positional relationship information indicating the obtained positional relationship.

3. The apparatus according to claim 1, wherein said setting unit includes a recognition unit for performing speech recognition; and
in a case where the positional relationship information is input by speech, said recognition unit acquires and sets result of speech recognition, which has been applied to the input speech, as the positional relationship information.

4. An information processing apparatus for executing authentication processing on the basis of the authentication information generated by the information processing apparatus according to claim 1, comprising:
a display unit for displaying an image group in array form;
a determination unit for specifying an image being displayed at such a position that a positional relationship with respect to an image that is designated by the user in the image group displayed by said display unit will be a positional relationship indicated by positional relationship information contained in authentication information of interest corresponding to the user, and determining whether image information of the specified image matches image information of a pass image contained in the authentication information of interest; and
a unit for deciding that authentication has succeeded if said determination unit determines a match, and deciding that authentication has failed if said determination unit determines a non-match, thereby controlling subsequent processing.

5. The apparatus according to claim 4, wherein said display unit displays in array form a different image group whenever a designation indicating display of another image group is received; the pass image being included in any one of image groups to be displayed.

6. An information processing method comprising:
an acquisition step of acquiring image information of a pass image used at the time of authentication;
a setting step of setting positional relationship information indicating positional relationship between a designated position, which is to be designated on a screen by a user in a case where a plurality of images inclusive of the pass image are displayed on the screen at the time of authentication, and a display position of the pass image; and
a registration step of generating authentication information, which includes the image information acquired at the acquisition step and the positional relationship information that is set at the setting step, and registering the generated authentication information in a memory.

7. An information processing method performed by an information processing apparatus for executing authentication processing on the basis of the authentication information generated by the information processing apparatus according to claim 1, comprising:
a display step of displaying an image group in array form;
a determination step of specifying an image being displayed at such a position that a positional relationship with respect to an image that is designated by the user in the image group displayed at the display step will be a positional relationship indicated by positional relationship information contained in authentication information of interest corresponding to the user, and determining whether image information of the specified image matches image information of a pass image contained in the authentication information of interest; and
a step of controlling subsequent processing by deciding that authentication has succeeded if a match is determined at the determination step, and deciding that authentication has failed if a non-match is determined at the authentication step.

8. A computer-readable storage medium storing a computer program for causing a computer to function as each of the units of the information processing apparatus according to claim 1.
